(19) United States
(12) Patent Application Publication
(10) Pub. No.: US 2004/0034775 A1
(43) Pub. Date: Feb. 19, 2004

(54) Wireless probability ticket method and apparatus

(76) Inventors: Richard W. Desjardins, Coventry, RI (US); Edwin J. Gonzalez, Lighthouse Point, FL (US)

Correspondence Address: Ruben Alcoba, Esq., 17347 SW 20th Court, Miramar, FL, 33029, US

(21) Appl. No.: 10/324,442

(22) Filed: Dec. 19, 2002

Related U.S. Application Data
(60) Provisional application No. 60/404,284, filed on Aug. 19, 2002.

(51) Int. Cl. G06F 17/60

(52) U.S. Cl. 713/170; 463/29; 705/18

(57) ABSTRACT

This invention is wireless probability ticket that comprises a wireless device that initializes a transaction, a wireless carrier that connects to the wireless device and carries the transaction and a gaming transaction server connected to the carrier, wherein the gaming transaction server verifies and decrypts messages, identifies users of the wireless device, and sends a two layered message, the two layered message having a first layer and a predetermined second layer, wherein the gaming transaction server sends the first layer of the two layered message to the wireless device, thereby permitting the user of the wireless device to make a selection of at least one choice from the first layer, wherein the user selection is then sent to the gaming transaction server, and the gaming transaction server logs and tracks the choices received from the wireless device and further decrypts the second layer of the two layered message and then sends the second layer to the wireless device, wherein the wireless device further decrypts the second layer and then the wireless device reveals the subset of the predetermined second layer that corresponds to the subset chosen from the first layer of the two layered message. The invention has various derivations of the above embodiment.

### CROSS REFERENCE

The present application is claiming priority from a provisional application having serial No. 60/404,284 filed in the year of 2002, entitled “Wireless Instant Probability Ticket,” filed by Richard W. Desjardins, one of the inventors.

### BACKGROUND

This invention is in the art of online wireless gaming, more specifically, this is a wireless probability ticket apparatus and a method of its use.

Games of chance have been popular for centuries. In the past, games of chance have been used to finance explorations and wars. But, only in the recent past, have games of chance moved from an offline multi-part paper format to an online venue. This online venue initially was exploited over a wired system. In the wired online gaming industry, a vendor generally provides a game of chance that has redundant central systems, software, communications networks, point of sales terminals and service infrastructures. These wired systems are extremely secure high volume transaction engines capable of supporting 100,000's of transactions per minute, yet they have one disadvantage, the end user ultimately has to go to a third party point of sales terminal to access the games or subscribe to an internet online carrier to access the gaming engine/website running the game.

The emergence of wireless technology has provided an alternative venue to provide gaming to consumers. Via the use of wireless devices, consumers now are able to use their wireless devices as point of sales terminals, thereby eliminating the need to go to a third party point of sales terminal.

This invention is geared to a specific type of gaming system, that being one of probability ticket. Probability tickets are tickets that guarantee that every ticket has a potential prize underneath. In a probability game, a player reveals a subset from a first layer and tries to match the subset hidden beneath the first layer, if the subsets match, then the player is deemed a winner. In the past, probability tickets have not achieved widespread success in their current multi-layer paper format where various chemical based coatings are used to secure the underlying layer information from view. This is because the paper format tickets were still susceptible to tampering and they required an unreasonable level of accuracy when scratching off the first layer in order to not invalidate the ticket by inadvertently exposing too much of an adjacent location. The tickets were also susceptible to damage when carried in a wallet, pocket or purse. Another disadvantage that the gaming agents face is that providing this paper format is expensive to produce and has been proven to produce hazards to the environment. A further disadvantage, when dealing with unscrupulous vendors, has been the accountability of each transaction.

### SUMMARY

The present invention is directed to a wireless probability ticket apparatus and its method of use that prevents users from selecting unwanted choices from a first layer of a wireless probability ticket, that prevents users from tampering with the probability ticket, that allows itself to be monitored by disinterested third parties or regulatory agents, and that minimizes paper and chemical waste associated with offline multipart paper probability tickets. The wireless probability ticket having features of the present invention comprises a wireless device, a wireless carrier connected the wireless device, a gaming transaction server connected to the wireless carrier. The wireless device has the capacity to be loaded with programs online via the wireless carrier and said programs may be sent from the gaming transaction server. In the present invention, the wireless device would initiate a transaction, then the gaming transaction server would send the wireless device a two layered message, the two layered message having a first layer and a predetermined second layer, wherein only the first layer would be initially revealed to the wireless device. The user of the wireless device would then select choices from the first layer and then send the choices to the gaming transaction server, upon the receipt of the first layer by the gaming transaction server, the gaming transaction server would then release a predetermined second layer to the wireless device. The wireless device would then display a subset of the predetermined second layer that corresponds to first layer.

In a further embodiment of the above invention, the wireless probability ticket further comprises a tracking engine that records all messages sent between the wireless device to the gaming transaction server so that third parties can monitor the accuracy of the transaction. The wireless device of the wireless probability ticket can also be preloaded with a program that displays a confirmation mechanism on the wireless device that can be read by a reader at predetermined prize validation sites.

The above wireless instant probability ticket concept is based on four fundamental components.

1. A gaming provider. This may be a Lottery, or a combination of a Lottery and a third party provider or a non-lottery provider such as in the case of marketing type games where no license may be required.

2. The instant ticket concept in general, which is a game in which a player purchases a pre-printed ticket that has symbols which must be scratched off to reveal a prize amount underneath. If the correct number of locations uncovered show identical prize amounts, or in some cases add up to a larger number (such as in the baseball type games) or produces a pre-defined string, the player the player wins.

The difference between probability instant ticket games and regular instant ticket games is that in the probability game the ticket is always a potential winner. Unlike the regular game, in the probability game the player is only allowed to uncover a subset of the total icons available. So the player must pick the icons in the right locations in order to win. There have been attempts to create this type of ticket in the paper format but concerns of tampering have caused it not to proliferate as of this writing. In any event, because of the nature of this type of instant game the wireless version will also run differently from the normal wireless instant ticket.

3. Wireless communication technologies both existing and future that have the capability of carrying data sufficient to the needs of the game.

4. Cellular Phones, PDA's, Portable Computers, and any other mobile devices capable of connecting to existing and future wireless networks.

By utilizing the components listed above in the proper manner it is possible to connect a gaming type transaction engine (gaming transaction server) to the wireless subscriber/user (player) and offer instant ticket type games by making use of the text and graphics capabilities of the mobile devices (wireless devices).

Images of instant ticket type (probability) games would appear on the mobile device screen and the player would use keypad, touch screen or voice commands to uncover the locations and determine if they are a winner. This image may contain animation and may be generated in one of three ways.

1. Both layers of the ticket are initiated by an application in the cell phone (wireless device) that interprets a message from the gaming engine to create a specific two-layered ticket image (that may be encrypted), a copy of which resides in the gaming system. For security reason the application in the phone (wireless device) does not create the lower level (predetermined second layer (prize image) until the player has actually selected that particular location. The second layer contents are predetermined by the gaming transaction server (engine) and are embodied in the message(s) sent from said engine. Alternatively, it would be possible for the gaming engine to send a message that would cause a program in the device to generate the second layer icons, but the gaming engine would always know the makeup of the second layer contents prior to the subset of the second layer being generated on the wireless device.

2. The first layer of the ticket is generated on the screen and the second layer is not created until the player has selected all of the locations allowed by the game and those selections are sent back to the gaming system. This can also be done one icon selection at a time but it would result in additional transactions and slow the game play down.

3. The entire ticket message is sent to an intermediate server such as the player's subscription service server, where the ticket is logged and only the upper layer is forwarded to the player. The player then makes his/her selections based on number 1 or 2 above. This method places a third party in the middle of the transaction that can verify that the ticket, as sent from the gaming system, was in fact a potential winner.

In either case there is a tracking mechanism associated with each individual wireless instant ticket. The tracking mechanism can be a MSISDN, a serial number, a user's hardware or software mobile ID number, or any other means known in the art of wireless communications. In some cases, the serial number used to track each transaction may be generated by an algorithm that would be based upon the mobile device identification number and/or the user's password. In any event, there will be some security mechanism employed to link the transaction with the gaming system (gaming transaction server), the user, and the user's mobile device (wireless device).

### DRAWINGS

These and other features, aspects, and advantages of the present invention will become better understood with regard to the following description, appended claims, and accompanying drawings where:

FIG. 1 shows one version of a wireless probability ticket;

FIG. 2 shows another version of the wireless probability ticket;

FIG. 3 shows a further version of the wireless probability ticket;

FIG. 4 shows another version of the wireless probability ticket; and

FIG. 5 shows yet a further version of the wireless probability ticket.

### DESCRIPTION

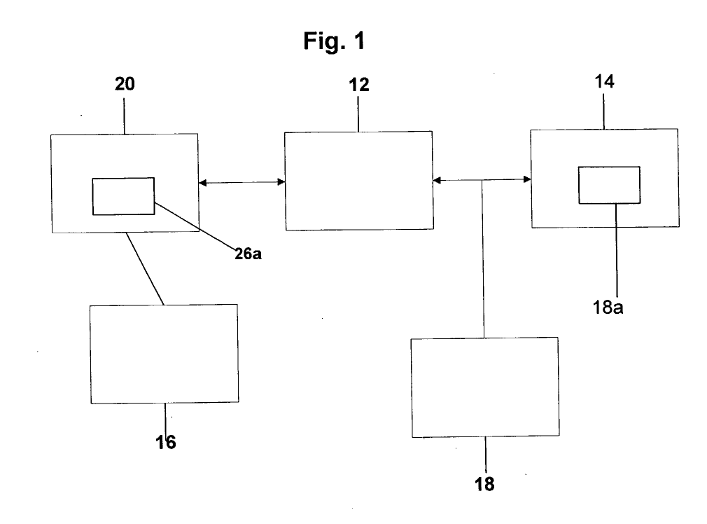

As shown in FIG. 1, a wireless probability ticket comprises a wireless device 10 that connects via a wireless carrier 12 to a gaming transaction server 14. The wireless device 10 can be any portable device that can receive and decrypt data or voice messages, store applications within, and run applications within, such as a cellular phone, a personal digital assistant, a portable computer, or any other mobile device capable of connecting to existing and future wireless networks. The wireless carrier 12 can be any system used to relay wireless messages between two locations. The gaming transaction server 14 can be any server/engine geared to do the following functions: random number or icon generation, serial number assignment, serial number verification, encryption, decryption, generating and storing combinations of two layered messages, tracking two layered transactions, generating random algorithms for each two layered message, generating keys to decrypt messages, sending two layered messages in sequences determined by the operators of the gaming transaction server, generating prize structures for each transaction, generating security features for each game, and possibly monitoring wireless devices, thereby preventing users from decrypting the two layered message through illicit means.

The embodiment of the wireless probability ticket described in FIG. 1 would function as follows: the wireless device 10 would initiate a transaction via the wireless carrier 12 requesting a wireless probability ticket, the gaming transaction server 14 would verify that the request is valid, would log the request and then send the first layer of a two layered message to the wireless device 10 so that the user of the wireless device 10 can select at least one choice from the choices sent to the wireless device 10 from the gaming transaction server 14. The user then would send the choice(s) made from the first layer to the gaming transaction server 14 so that the choices can be logged on the gaming transaction server 14 and then the second layer can be relayed to wireless device 10, the gaming transaction server 14 would also determine if the choices made by the user define a subset of the second layer that determines a winning ticket. All of the above user initiated transactions would be logged and kept in database in the gaming transaction server 14 so that verification of all events occurring in the wireless device 10 and in the gaming transaction server 14 could be tracked. The wireless probability ticket described above is based on the concept that every transaction has a predetermined winner in the second layer of the two layered message, whether that winner be an instant ticket or any other prize. The user's selections from the first layer are what uncovers the second layer, every second layer will have a subset defining a winner, the subset could be a one choice subset (an free instant ticket for instance) or a string (the string may have to display three of a kind or a combination of choices predetermined to be winners). The first layer of choices delivered to the wireless device 10 ideally would display up to nine choices, but any plurality of choices is possible, and the user receiving those choices would select at least one choice from the first layer and then send the selection to the gaming transaction server 14 for prize determination.

The embodiment of FIG. 1 can be programmed at the wireless device 10 to decrypt and show a serial number or an image corresponding to the second layer subset or in the alternative the gaming transaction server 14 can send a serial number or image corresponding to the subset of the second layer to the wireless device 10 so that the user can determine if user initial selections resulted in a winning wireless probability ticket.

By programming either the wireless device 10 (to decrypt a message that corresponds to the subset of the second layer) or the gaming transaction server 14 (to send a serial number or image derived from an algorithm that corresponds to the subset of the second layer) to reveal the serial number or image sent above the user can be ensured that his selection is not only a winner but also that the transaction has a log entry that can be later validated.

The embodiment of FIG. 1 can further comprise of a tracking engine 18 that tracks and records all messages sent between the wireless device 10 and the gaming transaction server 14. The tracking engine 18 can be a separate server placed between the wireless device and the gamming transaction server or a program 18a that runs within the gaming transaction server 14 that can be verified by third parties who would have an access code to access the records of the gaming transaction server 14.

The reason for the tracking engine 18 is so that any third party can account for the validity/accuracy of the wireless probability ticket. A further function of the transaction engine 18 is to manage the game presentations across numerous wireless network platforms. The third party can be any accountability firm that can reassure the public of the fairness of the game. Presumably the third party would have an access code to access the records of the tracking engine when the tracking engine is a program 18a within the gaming transaction server 14.

The embodiment of FIG. 1 may further have a reader 16 that can read the images displayed on the wireless device 10 when the wireless device 10 is placed in contact with the reader 16 by any means known in the art. The reader may also be a program within the wireless device 16a that sends a prize message to the gaming transaction server 14.

The reason for the reader 16 would be to allow users of the wireless device 10 to go to prize validation sites to redeem their prizes. If the reader is a program within the wireless device 16a, the program would send a message to the gaming transaction server 14 instructing the gaming transaction server 14 to award cell cash to the user of the wireless device 1. Cell cash is defined hereinafter as the monies or credits deposited into user's account.

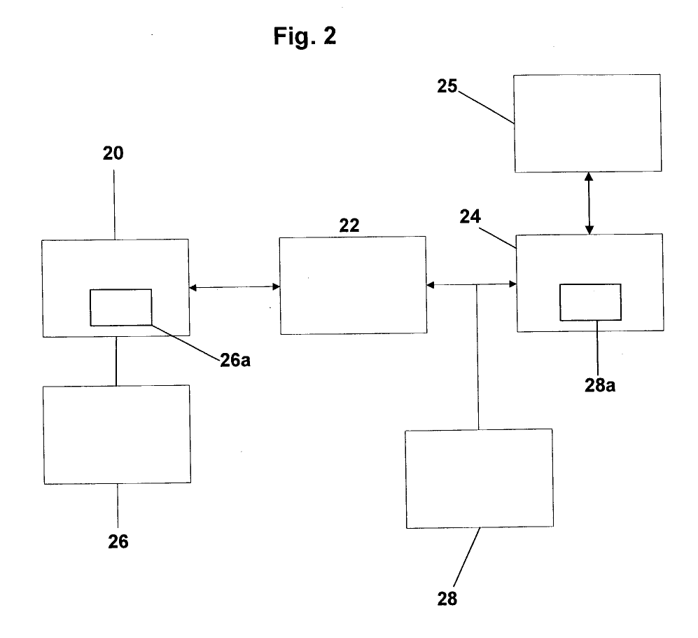

Another embodiment of the invention is shown in FIG. 2, a wireless probability ticket comprises a wireless device 20 connected via a wireless carrier 22 to a transaction server 24 which can be connected to a gaming server 25 (for example, an external lottery provider) either via the wireless carrier 22 or intranet. The wireless device 20 can be any portable device that can receive and decrypt data or voice messages, store applications within, and run applications within, such as a cellular phone, a personal digital assistant, a portable computer, or any other mobile device capable of connecting to existing and future wireless networks. The wireless carrier 22 can be any system used to relay wireless messages between two locations. The transaction server 24 can be any server/engine geared to do the following functions: random number or icon generation, serial number assignment, serial number verification, encryption, decryption, generating and storing combinations of two layered messages, tracking two layered transactions, generating random algorithms for each two layered message, generating keys to decrypt messages, sending two layered messages in sequences determined by the operators of the gaming transaction server, generating prize structures for each transaction, generating security features for each game, and possibly monitoring wireless devices, thereby preventing users from decrypting the two layered message through illicit means. The gaming server 25 will generate two layered messages (said layered messages having a first layer and a predetermined second layer, in which the selections made from the first layer will uncover a subset from the second layer) and store a record of all transactions sent to transaction server. The gaming server 25 may generate or process prize structures for each transaction and/or generate or process security features for each game. The two-layered messages generated in the gaming server will be based on an algorithm that will insure that every second layer has the possibility of being a winner.

The above embodiment would function by having a user initiate a transaction from the wireless device 20 that would be carried via the wireless carrier 22 to the transaction server 24. The transaction server 24 would then verify the transaction to determine if an authorized user has initiated the transaction. If the transaction is authentic, then the transaction server 24 would request a wireless probability ticket (a two layered message) from the gaming server 25. The gaming server 25 would then send the two layered message to the transaction server 24, where only the first layer message would be relayed to the wireless device 20. The first layer message will allow the user of the wireless device 20 to select at least one choice from a plurality of choices that once selected will create a first layer subset that will be sent back to transaction server 24. The transaction server 24 will then decipher whether the first layer subset corresponds to a second layer subset that would define a winner. Every second layer message must have at least a second layer subset defining a winner, whether the second layer subset is a selection of one (as in a free instant ticket for instance) or a string (the string may have to display three of a kind or a combination of choices predetermined to be a winner). The transaction server 24 then would relay the second layer message to the wireless device 20 so that the user can be notified whether the choices made from the first layer subset correspond to the second layer subset defining a winner. The transaction server 24 and the gaming server 25 may have internal databases that log each transaction so that accountability can be verified by any third parties.

The embodiment of FIG. 2 can be programmed at the wireless device 20 to show a serial number or an image corresponding to the second layer subset or in the alternative the transaction server 24 can send a serial number or image corresponding to the subset of the second layer to the wireless device 20 so that the user can determine if user initial selections resulted in a winning wireless probability ticket.

By programming either the wireless device 20 (to decrypt a message that corresponds to the subset of the second layer) or the transaction server 24 (to send a serial number or image derived from an algorithm that corresponds to the subset of the second layer) to reveal the serial number or image sent above the user can be ensured that his selection is not only a winner but also that the transaction has a log entry that can be later validated.

The embodiment of FIG. 2 can further comprise of a tracking engine 28 that tracks and records all messages sent between the wireless device 20 and the transaction server 24. The tracking engine 28 can be a separate server placed between the wireless device 20 and the transaction server 24 or a program 28a that runs within the transaction server 24 that can be verified by third parties who would have an access code to access the records of the transaction server 24.

The reason for the tracking engine 28 is so that any third party can account for the validity/accuracy of the wireless probability ticket. A further function of the transaction engine 28 is to manage the game presentations across numerous wireless network platforms. The third party can be any accountability firm that can reassure the public of the fairness of the game. Presumably the third party would have an access code to access the records of the tracking engine when the tracking engine is a program 28a within the transaction server 24.

The embodiment of FIG. 2 may further have a reader 26 that can read the images displayed on the wireless device 20 when the wireless device 20 is placed in contact with the reader 26 by any means known in the art. The reader may also be a program within the wireless device 26a that sends a prize message to the transaction server 24.

The reason for the reader 26 would be to allow users of the wireless device 20 to go to prize validation sites to redeem their prizes. If the reader is a program within the wireless device 26a, the program would send a message to the transaction server 24 instructing the transaction 24 to award cell cash to the user of the wireless device 20.

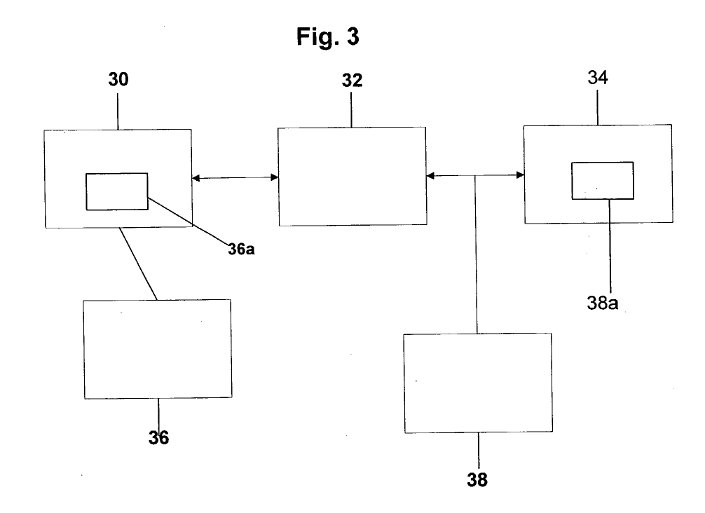

Yet another embodiment of the invention is shown in FIG. 3, a wireless probability ticket comprises a wireless device 30 that connects via a wireless carrier 32 to a gaming transaction server 34. The wireless device 30 can be any portable device that can receive and decrypt data or voice messages, store applications within, and run applications within, such as a cellular phone, a personal digital assistant, a portable computer, or any other mobile device capable of connecting to existing and future wireless networks. The wireless carrier 32 can be any system used to relay wireless messages between two locations. The gaming transaction server 34 can be any server/engine geared to do the following functions: random number or icon generation, serial number assignment, serial number verification, encryption, decryption, generating and storing combinations of two layered messages, tracking two layered transactions, generating random algorithms for each two layered message, generating keys to decrypt messages, sending two layered messages in sequences determined by the operators of the gaming transaction server, generating prize structures for each transaction, generating security features for each game, and possibly monitoring wireless devices, thereby preventing users from decrypting the two layered message through illicit means.

The embodiment of the wireless probability ticket described in FIG. 3 would function as follows: the wireless device 30 would initiate a transaction via the wireless carrier 32 requesting a wireless probability ticket, the gaming transaction server 34 would verify that the request is valid, would log the request and then send a two layered message, having a first layer and a second layer, to the wireless device 30, the wireless device 30 would initially only be allowed to decrypt the first layer of the two layered message and the user of the wireless device 30 would then select at least one choice from the first layer of the two layered message and then send the choice(s) made from the first layer to the gaming transaction server 34 so that the choices can be logged on the gaming transaction server 34, once logged, the gaming transaction engine would send a key to the wireless device 30 instructing the wireless device 30 to reveal a subset of the second layer of the two layered message that corresponds to subset initially chosen from the first layer. All of the above user initiated transactions would be logged and kept in database in the gaming transaction server 34 so that verification of all events occurring in the wireless device 30 and in the gaming transaction server 34 is tracked. The wireless probability ticket described above is based on the concept that every transaction has a predetermined winner in the second layer of the two layered message, whether that winner be an instant ticket or any other prize. The user's selections from the first layer is what uncovers the subset of the second layer, every second layer will have a subset defining a winner, the subset can be a one choice subset (a free instant ticket for instance) or a string (the string may have to display three of a kind or a combination of choices predetermined to be winners). The first layer of choices (from the first layer of the two layered message) delivered to the wireless device 30 ideally would display up to nine choices, but any plurality of choices is possible, and the user receiving those choices would select at least one choice from the first layer and then send the selection to the gaming transaction server 34 to receive a key that will allow user to determine if he has been awarded a prize based on his initial selections.

The embodiment of FIG. 3 can be programmed at the wireless device 30 to decrypt and show a serial number or an image corresponding to the second layer subset or in the alternative the gaming transaction server 34 can send a serial number or image corresponding to the subset of the second layer to the wireless device 30 so that the user can determine is user initial selections resulted in a winning wireless probability ticket.

By programming either the wireless device 30 (to decrypt a message that corresponds to the subset of the second layer) or the gaming transaction server 34 (to send a serial number or image derived from an algorithm that corresponds to the subset of the second layer) to reveal the serial number or image sent above the user can be ensured that his selection is not only a winner but also that the transaction has a log entry that can be later validated.

The embodiment of FIG. 3 can further comprise of a tracking engine 38 that tracks and records all messages sent between the wireless device 30 and the gaming transaction server 34. The tracking engine 38 can be a separate server placed between the wireless device and the gamming transaction server 34 or a program that runs within the gaming transaction server 38a that can be verified by third parties who would have an access code to access the records of the gaming transaction server 34.

The reason for the tracking engine 38 is so that any third party can account for the validity/accuracy of the wireless probability ticket. A further function of the transaction engine 38 is to manage the game presentations across numerous wireless network platforms. The third party can be any accountability firm that can reassure the public of the fairness of the game. Presumably the third party would have an access code to access the records of the tracking engine when the tracking engine is a program 38a within the gaming transaction server 34.

The embodiment of FIG. 3 may further have a reader 36 that can read the images displayed on the wireless device 30 when the wireless device 30 is placed in contact with the reader 36 by any means known in the art. The reader may also be a program within the wireless device 36a that sends a prize message to the gaming transaction server 34.

The reason for the reader 36 would be to allow users of the wireless device 30 to go to prize validation sites to redeem their prizes. If the reader is a program within the wireless device 36a, the program would send a message to the gaming transaction server 34 instructing the gaming transaction server 34 to award cell cash to the user of the wireless device 30.

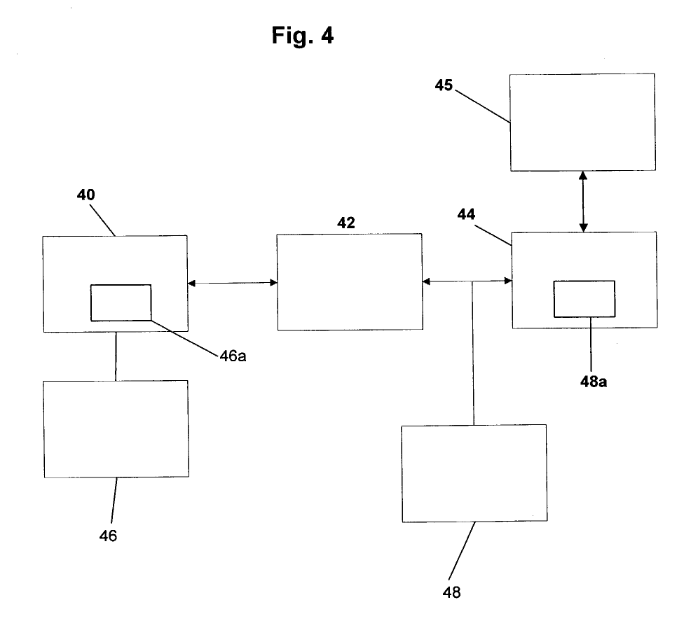

Still another embodiment of the invention is shown in FIG. 4, a wireless probability ticket comprises a wireless device 40 connected via a wireless carrier 42 to a transaction server 44 which can be connected to a gaming server 45 (for example, an external lottery agent) either via the wireless carrier 42 or intranet. The wireless device 40 can be any portable device that can receive and decrypt data or voice messages, store applications within, and run applications within, such as a cellular phone, a personal digital assistant, a portable computer, or any other mobile device capable of connecting to existing and future wireless networks. The wireless carrier 42 can be any system used to relay wireless messages between two locations. The transaction server 44 can be any server/engine geared to do the following functions: random number or icon generation, serial number assignment, serial number verification, encryption, decryption, generating and storing combinations of two layered messages, tracking two layered transactions, generating random algorithms for each two layered message, generating keys to decrypt messages, sending two layered messages in sequences determined by the operators of the gaming transaction server, generating prize structures for each transaction, generating security features for each game, and possibly monitoring wireless devices, thereby preventing users from decrypting the two layered message through illicit means. The 45 gaming server will generate two layered messages (said layered messages having a first layer and a predetermined second layer, in which the selections made from the first layer will uncover a subset from the second layer) and store a record of all transactions sent to transaction server. The gaming server 45 may also generate or process prize structures for each transaction and/or generate or process security features for each game The two layered messages generated in the gaming server will be based on an algorithm that will insure that every second layer has the possibility of being a winner.

The above embodiment would function by having a user initiate a transaction from the wireless device 40 that would be carried via the wireless carrier 42 to the transaction server 44. The transaction server 44 would then verify the transaction to determine if an authorized user has initiated the transaction. If the transaction is authentic, then the transaction server 44 would request a wireless probability ticket (a two layered message) from the gaming server 45. The gaming server 45 would then send the two layered message to the transaction server 44. The transaction server 44 then logs the message and then relays the two layered message, the two layered message having a first layer and a second layer, to the wireless device 40. The user of the wireless device 40 would then make selections from the first layer of the two layered message constituting a first subset and then send the first subset to the transaction server 44. The transaction server 44 then logs the first subset of choices and then determine if the first subset of choices correspond to a predetermined subset of the second layer, if so, then the two layered message would be logged as a winner. Then the transaction server sends the wireless device a key instructing the wireless device 40 to decrypt and show the user the results of his transaction. Every second layer message must have at least a second layer subset defining a winner, whether the second layer subset is a selection of one (as in a free instant ticket, for instance) or a string (the string may have to display three of a kind or a combination of choices predetermined to be a winner). The transaction server 44 and the gaming server 45 may have internal databases that log each transaction so that accountability can be verified by any third parties.

The embodiment of FIG. 4 can be programmed at the wireless device 40 to show a serial number or an image corresponding to the second layer subset or in the alternative the transaction server 44 can send a serial number or image corresponding to the subset of the second layer to the wireless device 40 so that the user can determine if user initial selections resulted in a winning wireless probability ticket.

By programming either the wireless device 40 (to decrypt a message that corresponds to the subset of the second layer) or the transaction server 44 (to send a serial number or image derived from an algorithm that corresponds to the subset of the second layer) to reveal the serial number or image sent above the user can be ensured that his selection is not only a winner but also that the transaction has a log entry that can be later validated.

The embodiment of FIG. 4 can further comprise of a tracking engine 48 that tracks and records all messages sent between the wireless device 40 and the transaction server 44. The tracking engine 48 can be a separate server placed between the wireless device 40 and the transaction server 44 or a program 48a that runs within the transaction server 44 that can be verified by third parties who would have an access code to access the records of the transaction server 44.

The reason for the tracking engine 48 is so that any third party can account for the validity/accuracy of the wireless probability ticket. A further function of the transaction engine 48 is to manage the game presentations across numerous wireless network platforms. The third party can be any accountability firm that can reassure the public of the fairness of the game. Presumably the third party would have an access code to access the records of the tracking engine when the tracking engine is a program 48a within the transaction server 44.

The embodiment of FIG. 4 may further have a reader 46 that can read the images displayed on the wireless device 40 when the wireless device 40 is placed in contact with the reader 46 by any means known in the art. The reader may also be a program within the wireless device 46a that sends a prize message to the transaction server 44.

The reason for the reader 46 would be to allow users of the wireless device 40 to go to prize validation sites to redeem their prizes. If the reader is a program within the wireless device 46a, the program would send a message to the transaction server 44 instructing the transaction server 44 to award cell cash to the user of the wireless device 40.

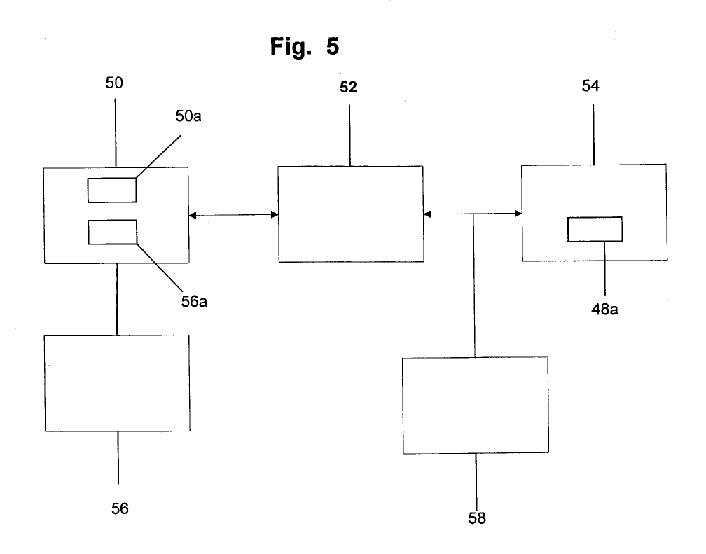

Another embodiment of the invention is shown in FIG. 5, a wireless probability ticket comprises a wireless device 50, that is downloaded with a program 50a that holds a two layered transaction that can be monitored over a wireless network, wherein the two layered transaction comprises of a first layer and a predetermined second layer, in which a user of the wireless device 50 first chooses at least one choice from a subset of the first layer and then instructs the wireless device 50 to reveal the predetermined second layer, a wireless carrier 52 that connects to the wireless device 50 and carries the results of the wireless device's two layered transaction to a transaction server 54, the transaction server 54 monitors the programs within the wireless device 50, loads and updates and verifies the cyclic redundancy check (CRC) (this is done to insure that wireless devices have not been tampered with) of the existing programs within the wireless device 50, verifies and decrypts messages, assigns serial numbers to each transaction, logs and tracks the results of each transaction, and identifies users of the wireless device 50. The wireless device 50 can be any portable device that can receive and decrypt data or voice messages, store applications within, and run applications within (for example, it will run a program that will display a game to the user, the program will allow the user to select choices from a first screen on the wireless device and then display a second screen showing the user whether his choices corresponded to a winning subset on the second screen), such as a cellular phone, a personal digital assistant, a portable computer, or any other mobile device capable of connecting to existing and future wireless networks. The wireless carrier 52 can be any system used to relay wireless messages between two locations. The transaction server 54 can be any server/engine geared to do the following functions: verification of the CRC of the application within the wireless device, decryption, store combinations of two layered messages, track two layered transactions, monitor of transactions, delivery system for wireless devices (programs sent from transaction engine to wireless devices), generate or process prize structures for each transaction, generate or process security features for each game, and an anti-tampering monitor of wireless device programs. The two layered transaction generated in the wireless device 50 will be based on an algorithm that will insure that every predetermined second layer has the possibility of being a winner.

The above embodiment would function by having a user initiate a transaction from the wireless device 50 that would be based on a probability game, in which the user would choose at least one choice from a first layer screen displayed on the wireless device and then a second layer screen would display results based on the choices chosen from the first layer screen, the results would be carried via the wireless carrier 52 to the transaction server 54. The transaction server 54 would then verify the transaction to determine if an authorized user has initiated the transaction. If the transaction is authentic, then the transaction server 54 would log and save the results of the transaction in a database within the transaction server. If the transaction is determined a winner, then the transaction server sends the wireless device an image or serial number that the user's wireless device will store in its internal memory so that the user can later redeem the winning transaction. Every second layer screen must have at least a second layer subset defining a winner, whether the second layer subset is a selection of one (as in a free instant ticket, for instance) or a string (the string may have to display three of a kind or a combination of choices predetermined to be a winner). The transaction server 54 may have internal databases that log each transaction so that accountability can be verified by any third parties.

The embodiment of FIG. 5 may be used to promote games that are beneficial to both users of a game and the sponsors of the game. For example, a sponsor of a particular game may be a vendor that needs to introduce a good or service into the stream of commerce and is willing to do so at a discounted cost to the user. This type of embodiment would not require the same security features as the previous, for the purpose of the embodiment is to have as many winners as possible, thereby promoting more vendor products and allowing users to benefit from same. Sponsors of this variation of game would insure that users play this type of game at a minimal cost, if any, and that the games generate a high probability of winners, for both the user and the sponsor benefit every time there is a winner. For example, the sponsor could have some type of game promotion that would require user's of the wireless device to visit sponsor's facility to pick up a prize, thereby encouraging a user to visit a facility that user may have never visited otherwise.

The embodiment of FIG. 5 can be programmed at the wireless device 50 to receive a serial number or image message sent from the transaction server 54 which would correspond to a winning transaction, wherein such message received would be encrypted so that the transaction server's validation sites/reader(s) would be able to validate winning transactions based on security protocols known in the art.

By programming the transaction server 54 to send a serial number or image derived from an algorithm that corresponds to the transaction, the user can be ensured that his selection is not only a winner but also that the transaction has a log entry that can be later validated, the serial number or image would be stored both in the wireless device 50 and in the transaction server 54.

The embodiment of FIG. 5 can further comprise of a tracking engine 58 that tracks and records all messages sent between the wireless device 50 and the transaction server 54. The tracking engine 58 can be a separate server placed between the wireless device 40 and the transaction server 54 or a program 58a that runs within the transaction server 54 that can be verified by third parties who would have an access code to access the records of the transaction server 54.

The reason for the tracking engine 58 is so that any third party can account for the validity/accuracy of the wireless probability ticket. A further function of the transaction engine 58 is to manage the game presentations across numerous wireless network platforms. The third party can be any accountability firm that can reassure the public of the fairness of the game. Presumably the third party would have an access code to access the records of the tracking engine when the tracking engine is a program 58a within the transaction server 54.

The embodiment of FIG. 5 may further have a reader 56 that can read the images displayed on the wireless device 50 when the wireless device 50 is placed in contact with the reader 56 by any means known in the art. The reader may also be a program within the wireless device 56a that sends a prize message to the transaction server 54.

The reason for the reader 56 would be to allow users of the wireless device 50 to go to prize validation sites to redeem their prizes. If the reader is a program within the wireless device 56a, the program would send a message to the transaction server 54 instructing the transaction server 54 to award cell cash to the user of the wireless device 50.

Note that in all of the above embodiments of the invention, the algorithm used in the case of instant tickets needs to guarantee the randomness of icon placement and type and at the same time must support a guarantee that at least one of the icons will match (which therefore is a random event). The algorithm may also be built to guarantee odds in terms of a large prize appearing on a winning ticket.

A method according to the present invention for gaming with a wireless probability ticket comprises the steps of choosing at least one choice from a wireless device that is preloaded with a program that holds a two layered transaction that can be monitored over a wireless network, wherein the two layered transaction comprises of a first layer and a predetermined second layer; instructing the wireless device to reveal the predetermined second layer; sending the result of the two layered transaction over a wireless network to a gaming transaction server; and logging the results of the transaction on a gaming transaction server. In the step of choosing at least one choice from the wireless device, the user would select at least one choice from the first screen of the wireless device and instruct the wireless device to go to a second screen which reveal whether the choices made by the user correspond to a subset of the predetermined second layer that would award a prize. In the sending step, the results of the transaction would be sent to a transaction server. In the logging step, the results of the transaction are logged, checked for accuracy and authenticity, and stored for later validation.

A further method according to the present invention for gaming with a wireless probability ticket comprises the steps of initializing a transaction on a wireless device; sending a first layer of a two layered message, wherein the two layered message has a first layer and a predetermined second layer message, from a gaming transaction server to the wireless device; choosing at least one choice from the first layer on the wireless device; then sending the choice(s) back to the gaming transaction server; then recording the choices made by the user on the gaming transaction server; and lastly, sending a key from the gaming transaction server to the wireless device that would decrypt the predetermined second layer. In the initializing step, the user of the wireless device would request a gaming transaction. In the sending step, a gaming transaction server would send a two layer message to the wireless device. In the choosing step, the user of the wireless device would choose at least one choice from a plurality of choices presented to him. In the second sending step, the user would instruct the wireless device to send the choices made in the above step to the gaming transaction server. In the recording step, the gaming transaction server would log and record the results chosen by the user. In the last sending step, the gaming transaction server would send a key to the wireless device that would decrypt the second layer so that the user could determine the results of the transaction.

A further method according to the present invention for gaming with a wireless probability ticket comprises the steps of initializing a transaction on a wireless device; sending the first layer of a two layered message, wherein the two layered message has a first layer and a predetermined second layer message, from a gaming transaction server to the wireless device; choosing at least one choice from the first layer on the wireless device; then sending the choice back to the gaming transaction server; repeating the above step as many times as required by the first layer instruction; then sending the predetermined second layer to the wireless device; and receiving a subset of the predetermined second layer that corresponds to the choices made from the first layer. All of the above steps would be done on a wireless device using any of the known cellular protocols known in the art.

The methods according to the present invention described above, for gaming with a wireless probability ticket, may further comprise of the step of granting a prize to the user of the wireless device when the choices made from the first layer correspond to a subset of the predetermined second layer awarding prize.

The methods according to the present invention described above, for gaming with a wireless probability ticket, may further comprise of the step of validating the wireless device at a vendor location so that the user of the wireless device can claim the prize.

Although the present invention has been described in considerable detail with reference to certain preferred versions thereof, other versions are possible. For example, it is also possible to update the device with the second layer information after each selection. This requires more messages back and forth but provides the user with the ability to see the outcome of each selection before making the next choice. Therefore, the spirit and scope of the appended claims should not be limited to the description of the preferred versions contained herein.

What is claimed is:

1. A wireless probability ticket, comprising
a wireless device that initializes a transaction;
a wireless carrier that connects to the wireless device and carries the transaction; and
a gaming transaction server connected to the carrier, wherein the gaming transaction server verifies and decrypts messages, identifies users of the wireless device, and sends a two layered message, the two layered message having a first layer and a predetermined second layer, wherein the gaming transaction server sends the first layer of the two layered message to the wireless device, thereby permitting the user of the wireless device to make a selection of at least one choice from the first layer, wherein the user selection is then sent to the gaming transaction server, and the gaming transaction server logs and tracks the choices received from the wireless device and further decrypts the second layer of the two layered message and then sends the second layer to the wireless device, wherein the wireless device further decrypts the second layer and then the wireless device reveals the subset of the predetermined second layer that corresponds to the subset chosen from the first layer of the two layered message.

2. The wireless probability ticket of claim 1, wherein the first layer received on the wireless device from the gaming transaction server displays a plurality of choices and the user of the wireless device chooses at least one choice from the first layer.

3. The wireless probability ticket of claim 2, wherein a prize is granted when the second layer subset defines a winner.

4. The wireless probability ticket of claim 3, wherein the wireless device generates or receives from the gaming transaction server a serial number or image that can be read by a reader at predetermined prize validation sites.

5. The wireless probability ticket of claim 4, further comprising a tracking engine that records all messages sent between the wireless device to the gaming transaction server so that third parties can monitor the accuracy of the transaction.

6. The wireless probability ticket of claim 3, wherein the wireless device receives a message from the gaming transaction server that can be confirmed at a validation site that awards prize.

7. The wireless probability ticket of claim 2, wherein a prize is determined from the choices made from user's selections, and the value of the prize is determined upon how many choices are initially selected by user from the first layer and wherein the prize is only awarded if all selections initially made from the first layer uncover a subset of the predetermined second layer awarding prize.

8. The wireless probability ticket of claim 2, wherein a prize is determined from the choices made from user's selections, and the value of the prize is determined upon how many choices are initially selected by user from the first layer and wherein the prize is awarded, if any, if selections initially made from the first layer uncover a subset of the predetermined second layer awarding prize.

9. A wireless probability ticket, comprising
a wireless device that initializes a transaction;
a wireless carrier that connects to the wireless device and carries the transaction;
a transaction server connected to the carrier, wherein the transaction server verifies and decrypts messages and further identifies a user of the wireless device; and
a gaming server that sends a two layered message, having a first layer and a predetermined second layer, to the transaction server, wherein the transaction server further sends the first layer of the two layered message to the wireless device, thereby permitting the user of the wireless device to make a selection of at least one choice from the first layer, wherein the user selection is then sent to the transaction server, and the transaction server logs and tracks the choices received from the wireless device and further decrypts the second layer of the two layered message and then sends the second layer to the wireless device, wherein the wireless device further decrypts the second layer and then the wireless device reveals a subset of the predetermined second layer that corresponds to the subset chosen from the first layer of the two layered message.

10. The wireless probability ticket of claim 9, wherein the first layer received on the wireless device from the transaction server displays a plurality of choices and the user of the wireless device chooses at least one choice from the first layer.

11. The wireless probability ticket of claim 10, wherein a prize is granted when the second layer subset defines a winner.

12. The wireless probability ticket of claim 11, wherein the wireless device generates or receives from the gaming server a serial number or image that can be read by a reader at predetermined prize validation sites.

13. The wireless probability ticket of claim 12, further comprising a tracking engine that records all messages sent between the wireless device to the transaction server so that third parties can monitor the accuracy of the transaction.

14. The wireless probability ticket of claim 11, wherein the wireless device receives a message from the gaming transaction server that can be confirmed at a validation site that awards prize.

15. The wireless probability ticket of claim 10, wherein a prize is determined from the choices made from user's selections, and the value of the prize is determined upon how many choices are initially selected by user from the first layer and wherein the prize is only awarded if all selections initially made from the first layer uncover a subset of the predetermined second layer awarding prize.

16. The wireless probability ticket of claim 10, wherein a prize is determined from the choices made from user's selections, and the value of the prize is determined upon how many choices are initially selected by user from the first layer and wherein the prize is awarded, if any, if selections initially made from the first layer uncover a subset of the predetermined second layer awarding prize.

17. A wireless probability ticket, comprising:
a wireless device that initiates a transaction;
a wireless carrier that connects to the wireless device and carries the transaction; and
a gaming transaction server connected to the carrier, wherein the gaming transaction server verifies and decrypts messages, identifies users of the wireless device, and sends a two layered message, the two layered message having a first layer and a predetermined second layer, to the wireless device and the wireless device decrypts only the first layer of the two layered message, the user of the wireless device then makes a selection of at least one choice from the first layer, wherein the user's selections are further sent to the gaming transaction server, and the gaming transaction server logs and tracks the choices received from the wireless device and then sends the wireless device a key to decrypt the second layer of the two layered message, wherein the wireless device further decrypts the second layer and then the wireless device reveals a subset of the predetermined second layer that corresponds to the subset chosen from the first layer of the two layered message.

18. The wireless probability ticket of claim 17, wherein the first layer received on the wireless device from the gaming transaction server displays a plurality of choices and the user of the wireless device chooses at least one choice from the first layer.

19. The wireless probability ticket of claim 18, wherein a prize is granted when the second layer subset defines a winner.

20. The wireless probability ticket of claim 19, wherein the wireless device generates or receives from the gaming transaction server a serial number or image that can be read by a reader at predetermined prize validation sites.

21. The wireless probability ticket of claim 20, further comprising a tracking engine that records all messages sent between the wireless device and the gaming transaction server so that third parties can monitor the accuracy of the transaction.

22. The wireless probability ticket of claim 19, wherein the wireless device receives a message from the gaming transaction server that can be confirmed at a validation site that awards prize.

23. The wireless probability ticket of claim 18, wherein a prize is determined from the choices made from user's selections, and the value of the prize is determined upon how many choices are initially selected by user from the first layer and wherein the prize is only awarded if all selections initially made from the first layer uncover a subset of the predetermined second layer awarding prize.

24. The wireless probability ticket of claim 18, wherein a prize is determined from the choices made from user's selections, and the value of the prize is determined upon how many choices are initially selected by user from the first layer and wherein the prize is awarded, if any, if selections initially made from the first layer uncover a subset of the predetermined second layer awarding prize.

25. A wireless probability ticket, comprising:
a wireless device that initiates a transaction;
a wireless carrier that connects to the wireless device and carries the transaction;
a transaction server connected to the carrier that verifies and decrypts messages received and identifies a user of the wireless device; and
a gaming server that sends a two layered message, the two layered message having a first layer and a predetermined second layer, to the transaction server, wherein the transaction server further sends the two layered message to the wireless device and the wireless device decrypts only the first layer of the two layered message, the user of the wireless device then makes a selection of at least one choice from the first layer, wherein the user's selections are further sent to the transaction server, and the transaction server logs and tracks the choices received from the wireless device and then sends the wireless device a key to decrypt the second layer of the two layered message, and the wireless device further decrypts the second layer and then reveals a subset of the predetermined second layer that corresponds to the subset chosen from the first layer of the two layered message.

26. The wireless probability ticket of claim 25, wherein the first layer received on the wireless device from the transaction server displays a plurality of choices and the user of the wireless device chooses at least one choice from the first layer.

27. The wireless probability ticket of claim 26, wherein a prize is granted when the second layer subset defines a winner.

28. The wireless probability ticket of claim 27, wherein the wireless device generates or receives from the gaming server a serial number or image that can be read by a reader at predetermined prize validation sites.

29. The wireless probability ticket of claim 28, further comprising a tracking engine that records all messages sent between the wireless device and the transaction server so that third parties can monitor the accuracy of the transaction.

30. The wireless probability ticket of claim 27, wherein the wireless device receives a message from the gaming transaction server that can be confirmed at a validation site that awards prize.

31. The wireless probability ticket of claim 26, wherein a prize is determined from the choices made from user's selections, and the value of the prize is determined upon how many choices are initially selected by user from the first layer and the prize is only awarded if all selections initially made from the first layer uncover a subset of the predetermined second layer awarding prize.

32. The wireless probability ticket of claim 26, wherein a prize is determined from the choices made from user's selections, and the value of the prize is determined upon how many choices are initially selected by user from the first layer and wherein the prize is awarded, if any, if selections initially made from the first layer uncover a subset of the predetermined second layer awarding prize.

33. A wireless probability ticket, comprising
a wireless device that is downloaded with a program that holds a two layered transaction that can be monitored over a wireless network, wherein the two layered transaction comprises of a first layer and a predetermined second layer, in which a user of the wireless device first chooses at least one choice from a subset of the first layer and then instructs the wireless device to reveal the predetermined second layer;
a wireless carrier that connects to the wireless device and carries the results of the two layered transaction; and
a transaction server connected to the wireless carrier, the transaction server monitors the programs within the wireless device, loads and updates the programs within the wireless device, verifies and decrypts messages, assigns serial numbers to each transaction, logs and tracks the results of each transaction, and identifies users of the wireless device.

34. The wireless probability ticket of claim 33, wherein the wireless device displays a plurality of choices to select from first layer and the user of the wireless device chooses at least one choice from the first layer.

35. The wireless probability ticket of claim 34, wherein a prize is granted when a second layer subset of the predetermined second layer defines a winner.

36. The wireless probability ticket of claim 35, further comprising a tracking engine that records all messages sent between the wireless device and the gaming transaction server so that third parties can monitor the accuracy of the transaction.

37. The wireless probability ticket of claim 36, wherein the wireless device generates or receives from the gaming transaction server a serial number or image that can be read by a reader at predetermined prize validation sites.

38. The wireless probability ticket of claim 35, wherein the wireless device receives a message from the gaming transaction server that can be confirmed at a validation site that awards prize.

39. A method for gaming with a wireless probability ticket comprises:
choosing at least one choice from a wireless device that is preloaded with a program that holds a two layered transaction that can be monitored over a wireless network, wherein the two layered transaction comprises of a first layer and a predetermined second layer;
instructing the wireless device to reveal the predetermined second layer;
sending the result of the two layered transaction over a wireless network to a gaming transaction server; and
logging the results of the transaction on a gaming transaction server that monitors the program, loads and updates the program, verifies and decrypts messages, assigns serial numbers to each transaction, logs and tracks the results of each transaction, and identifies users of the wireless device.

40. The wireless probability ticket method of claim 39, further comprising, granting a prize to the user of the wireless device when the first layer selections made by a user correspond to a subset of the predetermined second layer awarding prize.

41. The wireless probability ticket method of claim 40, further comprising, validating the wireless device at a vendor location so that the user can claim the prize.

42. A method for gaming with a wireless probability ticket comprises:
initializing a transaction on a wireless device;
sending a first layer of a two layered message, wherein the two layered message has a first layer and a predetermined second layer message, from a gaming transaction server to the wireless device;
choosing at least one choice from the first layer on the wireless device;
then sending the choice(s) back to the gaming transaction server;
then recording the choices made by the user on the gaming transaction server; and
lastly, sending a key from the gaming transaction server to the wireless device that would decrypt the predetermined second layer.

43. The wireless probability ticket method of claim 42, further comprising, granting a prize to the user of the wireless device when the first layer selections made by a user correspond to a subset of the predetermined second layer awarding prize.

44. The wireless probability ticket method of claim 43, further comprising, validating the wireless device at a vendor location so that the user can claim the prize.

45. The wireless probability ticket method of claim 46, further comprising, validating the wireless device at a vendor location so that the user can claim the prize.

46. A method for gaming with a wireless probability ticket comprises:
initializing a transaction on a wireless device;
sending the first layer of a two layered message, wherein the two layered message has a first layer and a predetermined second layer message, from a gaming transaction server to the wireless device;
choosing at least one choice from the first layer on the wireless device;
then sending the choice back to the gaming transaction server;
repeating the above step as many times as required by the first layer instruction;
then sending the predetermined second layer to the wireless device; and
receiving a subset of the predetermined second layer that corresponds to the choices made from the first layer.

47. The wireless probability ticket method of claim 46, further comprising, granting a prize to the user of the wireless device when the first layer selections made by a user correspond to a subset of the predetermined second layer awarding prize.

48. The wireless probability ticket method of claim 47, further comprising, validating the wireless device at a vendor location so that the user can claim the prize.
